(19) United States
(12) Patent Application Publication
(10) Pub. No.: US 2019/0091700 A1
(43) Pub. Date: Mar. 28, 2019

(54) SMART AIR PURIFICATION

(71) Applicant: KONINKLIJKE PHILIPS N.V., EINDHOVEN (NL)

(72) Inventors: RAINER HILBIG, EINDHOVEN (NL); ACHIM GERHARD ROLF KOERBER, EINDHOVEN (NL); PETER HERMANUS BOUMA, EINDHOVEN (NL); JING SU, EINDHOVEN (NL); JUN SHI, EINDHOVEN (NL)

(21) Appl. No.: 15/759,249

(22) PCT Filed: May 24, 2017
(86) PCT No.: PCT/EP2017/062530

§ 371 Date: Mar. 12, 2018

(30) Foreign Application Priority Data
May 31, 2016 (CN) PCT/CN2016/084062
Jul. 5, 2016 (EP) 16178018.4

(51) Int. Cl. B03C 3/36; F24F 7/007; B03C 3/12; B03C 3/41; B03C 3/47; H01T 23/00

(52) U.S. Cl. CPC B03C 3/368; F24F 7/007; B03C 3/12; F24F 2110/50; B03C 3/47; H01T 23/00; B03C 3/41

(57) ABSTRACT

An air purification apparatus (100) for purifying air in a target space external to the apparatus is disclosed that comprises at least one pollutant removal structure (130; 131, 132) for removing a pollutant from the air in fluid connection with a major vent (110) and a directional vent arrangement comprising a directional inlet (112) for drawing air into the air purification apparatus from a region of the target space in an aiming direction of the directional inlet; and a directional outlet (114) for expelling air in a further aiming direction towards the region. An air movement device (120; 121, 122) configured to move air from the directional inlet to the major vent in a first configuration and to move air from the major vent to the directional outlet through the at least one pollutant removal structure in a second configuration responsive to a controller (150) is also present, as well as a sensor (140) arranged to determine a concentration of the pollutant in the air in said region when the air movement device is in the first orientation, wherein the controller is responsive to the sensor and is adapted to switch the air movement device from the first configuration to the second configuration upon the concentration of the pollutant exceeding a defined pollutant concentration threshold.

### FIELD OF THE INVENTION

The present invention relates to an air purification apparatus for purifying air in a target space external to the apparatus, comprising at least one pollutant removal structure for removing a pollutant from the air and a directional vent arrangement.

### BACKGROUND OF THE INVENTION

Air quality is a major concern in modern society. Increasing pollutant levels have been associated with a rise in respiratory conditions such as asthma and allergies. This has caused an increase in the desire to control the quality of air where possible, e.g. in enclosed environments such as rooms, office spaces and the like, to reduce the risk that the inhabitants of such enclosed environments are exposed to pollutant such as pollen particles, soot particles and so on, which may cause respiratory distress.

This desire has led to an increased popularity in air purification apparatuses that can be deployed in such enclosed environments in order to capture potentially harmful pollutants, e.g. dust particles, pollen particles, gases, odours and so on, using one or more pollutant capturing devices, e.g. filters, catalytic converters, electrostatic precipitators, and so on. The one or more filters may include air filters such as carbon filters, HEPA filters, odour filters, anti-bacterial filters or the like. Catalytic converters may be used to break down gaseous pollutants into smaller molecules, e.g. H₂O and CO₂. Electrostatic precipitators may be employed for the removal of charged particles via collector plates. Other pollutant removal technologies employed in such purifiers are also known.

However, in order to maintain a healthy atmosphere in such enclosed environments, the air purification apparatus may have to displace relatively large volumes of air, in particular when the air purification apparatus has detected an elevated level of a pollutant of interest with an integrated pollutant sensor. This operation is typically associated with elevated noise levels and noticeable air streams, i.e. wind, coming from the air purification apparatus, which may be perceived as unpleasant by the inhabitants of the enclosed environment in which the air purification apparatus is operational. Moreover, the power consumption associated with such operation may be undesirable from an energy efficiency perspective.

These drawbacks have led to the emergence of air purification apparatuses that target specific areas within the enclosed environment, i.e. areas in which the presence of an object, e.g. a person, is detected, in order to create a micro-environment in this area. For example, JP 2006/314365 A discloses an air conditioner comprising a cabinet including an air blower under control of a controller that controls the operation of the air blower in response to an object sensor in order to control the air volume delivered to a specific area ahead of the cabinet. US 2014/260692 A1 discloses a system for determining indoor air contaminant levels independent of outdoor contaminant levels comprises air contaminant monitoring system having sensors to sense air contaminants/parameters to determine amount of indoor air contaminants. US 2003/206839 A1 discloses an air transporter-conditioner for removing particulates from air, which has ion generator that creates airflow between inlet and outlet, and germicidal lamp exposing airflow to germicidal radiation. Such an air purification apparatus is more efficient as it is typically only activated when on object in a target area is detected. However, such an air purification apparatus may still unnecessarily deliver air to the object.

### SUMMARY OF THE INVENTION

The present invention seeks to provide an air purification apparatus adapted to more discriminately deliver purified air to a target region.

According to an aspect, there is provided an air purification apparatus for purifying air in a target space external to the apparatus, comprising at least one pollutant removal structure for removing a pollutant from the air in fluid connection with a major vent and a directional vent arrangement comprising a directional inlet for drawing air into the air purification apparatus from a region of the target space in an aiming direction of the directional inlet; and a directional outlet for expelling air in a further aiming direction towards the region; an air movement device configured to move air from the directional inlet to the major vent in a first configuration and to move air from the major vent to the directional outlet through the at least one pollutant removal structure in a second configuration, the air movement device being responsive to a controller; a sensor arranged to determine a concentration of the pollutant in the air in said region when the air movement device is in the first orientation, wherein the controller is responsive to the sensor and is adapted to switch the air movement device from the first configuration to the second configuration upon the concentration of the pollutant exceeding a defined pollutant concentration threshold.

The air purification apparatus according to embodiments of the present invention intelligently delivers purified air towards a target region, e.g. a region including a subject such as a person, based on the detection of pollutant levels in the air drawn from the target region. In this way, the subject in the target region may only be subjected to a directional air flow in the direction of the target region when the pollutant levels exceed a defined threshold, which improves the efficiency of the air purification apparatus and decreases the incidence of the perceived discomfort by the subject from the directional air flow.

Preferably, the air purification apparatus further comprises a proximity sensor for detecting a person in said region, the controller being further responsive to the proximity sensor. This for instance has the advantage that activation of the second configuration only takes place when a person is detected in the target region, thus further improving the energy efficiency of the air purification apparatus.

The controller may be adapted to switch the air movement device from a standby configuration to the first configuration upon the detection of a person entering said region with the proximity sensor; and/or switch the air movement device from the first configuration to the standby configuration upon the detection of a person leaving said region with the proximity sensor to further improve the energy efficiency of the air purification apparatus.

In an embodiment, at least one of the aiming direction and the further aiming direction is adjustable. This has the advantage that the directional inlet and/or the directional outlet can follow the person, e.g. when the person moves to a different region within the target space. The aiming direction of the directional inlet and/or the directional outlet may be manually adjustable. Alternatively, the air purification apparatus may further comprise a motion detector, wherein the controller is adapted to adjust at least one of said aiming direction and said further aiming direction in response to the motion detector, which has the advantage that the person does not have to remember to adjust the directional inlet and/or the directional outlet when moving to a different region within the target space.

The inlet area of the directional inlet may be smaller than the outlet area of the directional outlet. This ensures that the air speeds at the outlet area are relatively low, i.e. lower than at the inlet area, which reduces the perceived draught coming from the air purification apparatus.

The directional inlet and the directional outlet may be spatially separated, which has the advantage that the directional inlet may be aimed at a different target within the region, e.g. below the nose and mouth of the subject, as the directional outlet, which may be arranged to deliver clean air to a volume around the nose and mouth of the subject such that the person inhales the clean air from this volume. Alternatively, the directional inlet and the directional outlet may coincide.

In an embodiment, the air movement device is configured to move air from the directional inlet to the major vent through the at least one pollutant removal structure in the first configuration. This has the advantage that in this pollutant sensing configuration, air is also purified, which improves the pollutant removal efficiency of the air purification apparatus.

The controller may be adapted to periodically switch the air movement device from the second configuration to the first configuration to determine an actual concentration of the pollutant in the air in said region with the sensor. In this way, the controller can terminate the delivery of purified air to the target region as soon as it is detected that the actual pollutant concentration has dropped below the defined threshold, thereby avoiding prolonged unnecessary operation of the air purification apparatus in the second configuration.

The air purification apparatus may comprise a plurality of said directional vent arrangements each aimed at a different region of the target space, each directional vent arrangement comprising a valve arrangement such that the controller can connect the air movement apparatus to different vent arrangements by control of the respective valve arrangements. This has the advantage that multiple regions of the target space may be targeted by the air purification apparatus.

The air purification apparatus may further comprise a further pollutant removal structure in the directional inlet to perform some pre-filtering of the inbound air.

In an embodiment, the air movement device comprises an electrode arrangement for generating an ionic wind, the electrode arrangement including opposing charging electrodes and a counter electrode arrangement in between the opposing charging electrodes. Such an air movement device has a particularly silent operation, which further reduces noise pollution by the air purification apparatus operating in the second configuration in particular.

The controller may be adapted to reverse the polarity of the opposing charging electrodes between the first configuration and the second configuration in order to reverse the direction of the air flow through the air purification apparatus. Alternatively, the counter electrode arrangement includes a first counter electrode arrangement adapted to cooperate with a first charging electrode of said opposing charging electrodes and a second counter electrode arrangement adapted to cooperate with a second charging electrode of said opposing charging electrodes, optionally wherein the opposing charging electrodes are longitudinally displaced relative to each other.

The at least one pollutant removal structure may comprise an electrostatic precipitation device to capture pollutants travelling through the air purification device.

### BRIEF DESCRIPTION OF THE DRAWINGS

Embodiments of the invention are described in more detail and by way of non-limiting examples with reference to the accompanying drawings, wherein:

FIG. 1 schematically depicts an air purification device according to an embodiment in a first configuration;

FIG. 2 schematically depicts an air purification device according to an embodiment in a second configuration;

FIG. 3 schematically depicts an air purification device according to another embodiment;

FIG. 4 schematically depicts an air purification device according to yet another embodiment;

FIG. 5 schematically depicts an air purification device according to a further embodiment in a first configuration;

FIG. 6 schematically depicts an air purification device according to a further embodiment in a second configuration;

FIG. 7 schematically depicts an air purification device according to another further embodiment;

FIG. 8 schematically depicts an air purification device according to yet another further embodiment;

FIG. 9 schematically depicts an air purification device according to still another further embodiment; and

FIG. 10 schematically depicts an aspect of an air purification device according to an embodiment in more detail.

### DETAILED DESCRIPTION OF THE EMBODIMENTS

It should be understood that the Figures are merely schematic and are not drawn to scale. It should also be understood that the same reference numerals are used throughout the Figures to indicate the same or similar parts.

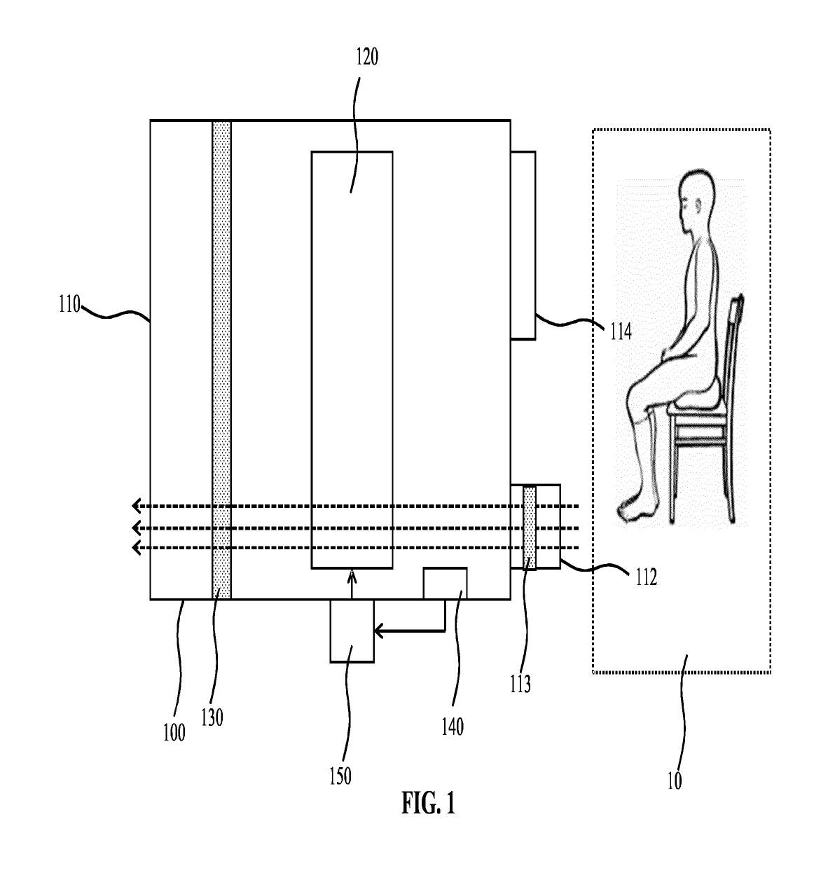

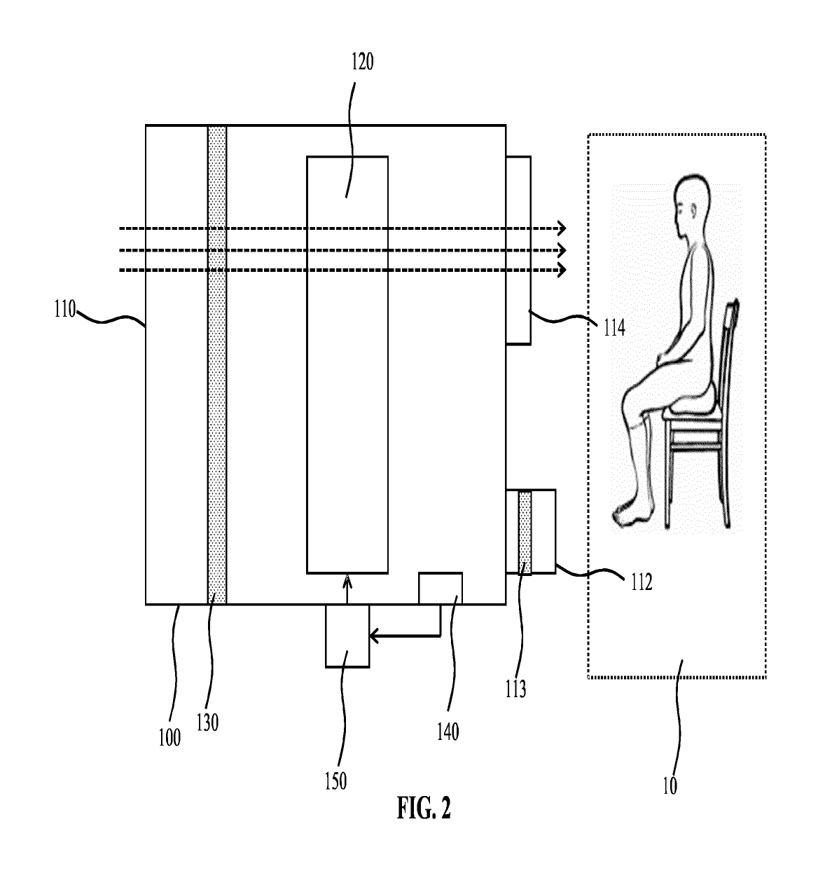

FIG. 1 schematically depicts an air purification apparatus 100 according to an embodiment in a first configuration and FIG. 2 schematically depicts the air purification apparatus 100 in a second configuration. The air purification apparatus 100 comprises a major vent 110 in fluid connection with a directional inlet 112 and a directional outlet 114 aimed at a region 10 of a target space such as a room, office space or the like housing the air purification apparatus 100. An air movement device 120 such as a fan, pump or the like fluidly connects the directional inlet 112 and the directional outlet 114 to the major vent 110. The major vent 110 preferably is arranged to displace air into or from a different region of the target space than the region 10. For example, the major vent 110 may be arranged at a different side surface of the air purification apparatus 100 compared to the directional inlet 112 and the directional outlet 114, e.g. opposite to the directional inlet 112 and the directional outlet 114.

In an embodiment, the air purification apparatus 100 comprises separate fluid channels including a first fluid channel extending between the directional inlet 112 and the major vent 110 and a second fluid channel extending between the directional outlet 114 and the major vent 110. The air movement device 120 may be adapted to displace air from the directional inlet 112 to the major vent 110 in the first configuration and to displace air from the major vent 110 to the directional outlet 114 in the second configuration. The air movement device 120 may comprise a first stage in the first fluid channel and a second stage in the second fluid channel, which stages may be independently controllable. The first stage and the second stage may comprise separate air movement devices 120.

In an alternative embodiment, the air purification apparatus 100 comprises a single fluid channel between the major vent 110 on the one hand and the directional inlet 112 and the directional outlet 114 on the other hand, in which case a valve arrangement may be provided that opens the directional inlet 112 and closes the directional outlet 114 in the first configuration and that closes the directional inlet 112 and opens the directional outlet 114 in the second configuration. Such a valve arrangement may comprise valves, e.g. solenoid valves, which may be controlled by the controller 150 to be described in more detail below, or alternatively may be mechanical valves that are forced in an open or shut position depending on the direction of the air flow, e.g. a hinged flap covering the directional inlet 112 and facing the major vent 110 and a hinged flap on the directional outlet 114 and facing the region 10.

The air purification apparatus 100 further comprises at least one pollutant removal structure 130, which for example may be one or more of a filter such as a HEPA filter, a carbon filter, a catalytic converter, an electrostatic precipitator, and so on, in order to remove pollutants such as particulate matter, pollen, odors, bacteria, formaldehyde and so on from the atmosphere in the volume in which such an air purification apparatus 100 is placed. The air purification apparatus 100 optionally may further comprise one or more pre-filters 113, e.g. a coarse particle filter or the like, which for example may be located in the directional air inlet 112.

The air purification apparatus 100 further comprises at least one pollutant sensor 140 arranged such that the sensor 140 can at least sense a concentration of a pollutant of interest in the air flow from the directional air inlet 112 to the major vent 110. The at least one pollutant sensor 140 is typically sensitive to a pollutant for which the air purification apparatus 100 comprises a pollutant removal structure 130. For example, the sensor 140 may be at least one of a particulate matter (PM) sensor for sensing particles of a certain size, e.g. a PM 1 sensor, a PM 2.5 sensor a PM 10 sensor and so on (the numerical value expresses an average particle size in μm), a gas sensor, a pollen sensor, a microorganism sensor, a (bio)aerosol sensor, a volatile organic compound (VOC) sensor, and an odour sensor. Other suitable sensor types are well-known per se and may also be contemplated.

The air purification apparatus 100 further comprises a controller 150 responsive to the at least one pollutant sensor 140 and adapted to control the air movement device 120 and the valve arrangement in the directional inlet 112 and the directional outlet 114 if present. Specifically, the controller 150 is adapted to switch the air purification apparatus 100 between the first configuration in which the air movement device 120 moves air from the directional inlet 112 to the major vent 110 and the second configuration in which the air movement device 120 moves air from the major vent 110 to the directional outlet 114. The controller 150 may be arranged to determine the concentration of a pollutant of interest from the sensor data provided by the at least one pollutant sensor 140 in the first configuration of the air purification apparatus 100 and to switch the air purification apparatus from the first configuration to the second configuration upon detecting that the concentration of the pollutant of interest has reached a critical level, e.g. has exceeded a defined pollutant concentration threshold. In this manner, the air purification apparatus 100 is configured to detect a pollutant level in the air sucked into the air purification apparatus 100 from the region 10 and deliver purified air to the region 10 upon detection of a critical pollutant level in the region 10 by switching the air purification apparatus 100 from the first configuration to the second configuration. Consequently, the air purification apparatus 100 implements smart air purification in a targeted region 10 by monitoring the actual pollutant levels in the region 10 and only delivering purified air to the targeted region 10 if the actual pollutant levels are considered unacceptably high. The controller 150 may be further adapted to operate the air movement device 120 at lower speeds in the first configuration compared to the second configuration, thereby reducing the power consumption by the air purification apparatus 100 in the first configuration.

In an embodiment, the controller 150 may be further adapted to periodically switch the air purification apparatus 100 from the second configuration to the first configuration to monitor the actual pollutant levels in the region 10. The controller 150 may be adapted to switch the air purification apparatus 100 back to the second configuration if it is determined that the actual pollutant levels are still too high, i.e. still exceed a defined pollutant concentration threshold or to maintain the air purification apparatus 100 in the first configuration if it is determined in step that the actual pollutant levels have dropped below the defined pollutant concentration threshold, such that active purification of the air in the region 10 no longer is required.

The controller 150 may be further adapted to maintain the air purification apparatus 100 in the second configuration for a predetermined amount of time. The predetermined amount of time may be defined as a function of the determined pollutant concentration in the region 10, such that the air purification apparatus 100 may operate for long enough in the second configuration to ensure that the pollutant concentration is reduced to acceptable levels.

The controller 150 may be further adapted to periodically switch the air purification apparatus 100 between the first configuration and a standby mode such that the quality of the air in the region 10 is only periodically sampled. The controller 150 may be adapted to set a sample frequency, i.e. the frequency of switching between the first configuration and the standby mode, as a function of a detected pollutant concentration in the air from the region 10. In this manner, in case of particularly low pollutant levels, it may be considered safe to less frequently sample the air quality in the region 10, given that it is unlikely that the sampled high air quality in the region 10 will rapidly deteriorate. The utilization of such a standby mode further improves the energy efficiency of the air purification apparatus 100.

At this point, it is noted that the controller 150 may be implemented in any suitable manner, e.g. as a single device such as a general purpose or application specific processor, or as a plurality of interconnected devices, e.g. a signal processor for processing the sensor signals from the at least one pollutant sensor 140 and a signal generator for generating the control signals for the air movement device 120 and the valve arrangement in the directional inlet 112 and the directional outlet 114 if present.

In an embodiment, the air inlet area of the directional inlet 112 is smaller than the air outlet area of the directional outlet 114. Consequently, for a given volume of air, the airflow speed through the directional inlet 112 will be higher than through the directional outlet 114, which has the advantage that an air is displaced through the directional outlet 114 towards the region 10 at relatively low at low speeds, such that a person residing is less likely to perceive the airflow through the directional outlet 114 towards the region 10 as discomforting or unpleasant. However, it should be understood that other arrangements, e.g. an arrangement in which the air inlet area of the directional inlet 112 is the same size or is larger than the air outlet area of the directional outlet 114, or an arrangement in which the directional inlet 112 coincides with the directional outlet 114, may also be contemplated.

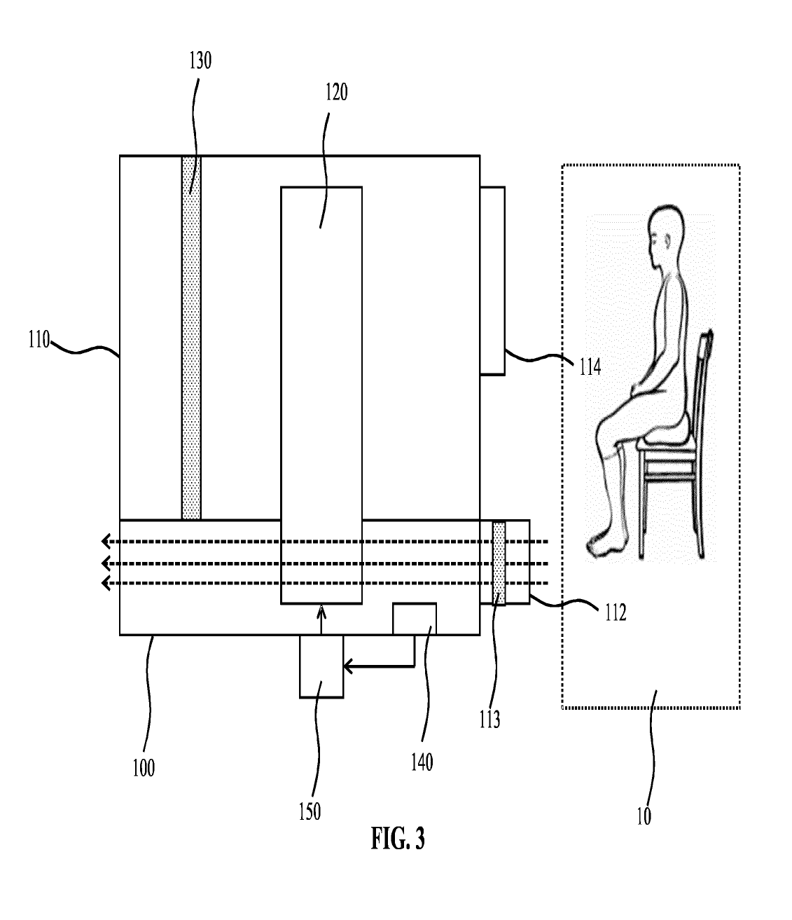

As schematically depicted in FIGS. 1 and 2, the at least one pollutant removal structure 130 may be arranged such that the airflow from the directional inlet 112 to the major vent 110 in the first configuration as well as the airflow from the major vent 110 to the directional outlet 114 in the second configuration pass through at least one of the pollutant removal structures 130, such that the air flowing from the directional inlet 112 to the major vent 110 also passes through at least one pollutant removal structure 130. In an alternative embodiment, which is schematically depicted in FIG. 3, the least one pollutant removal structure 130 may only be present in the flow path between the major vent 110 and the directional outlet 114 such that in the first configuration the air flowing from the directional inlet 112 to the major vent 110 through a flow path separate to the flow path between the major vent 110 and the directional outlet 114 does not pass through a pollutant removal structure 130, which has the advantage of improving the efficiency of the air purification apparatus 100 when operating in the first configuration due to the fact that less work is required by the air movement device 120 to move the air from the region 10 through the directional inlet 112 towards a further region through the main vent 110.

The air purification apparatus 100 in embodiments may be adapted to control a particulate matter, e.g. pollen, concentration in the region 10 such that a person in the region 10 is not exposed to levels of the particulate matter that may trigger an adverse reaction, e.g. an allergy attack for that person. In other embodiments, the air purification apparatus 100 may be adapted to detect elevated levels of VOCs in the region 10, which may be indicative of body odors or other malodors being generated in the region 10, e.g. by a person in that region, in response to which the air purification apparatus 100 may be switched to the second configuration by the controller 150 in order to quickly remove such malodors from the region 10, thereby reducing the risk of other people in the vicinity of the region 10 being exposed to such malodors, which may therefore help to prevent the person in the region 10 from being embarrassed by others being exposed to such malodors.

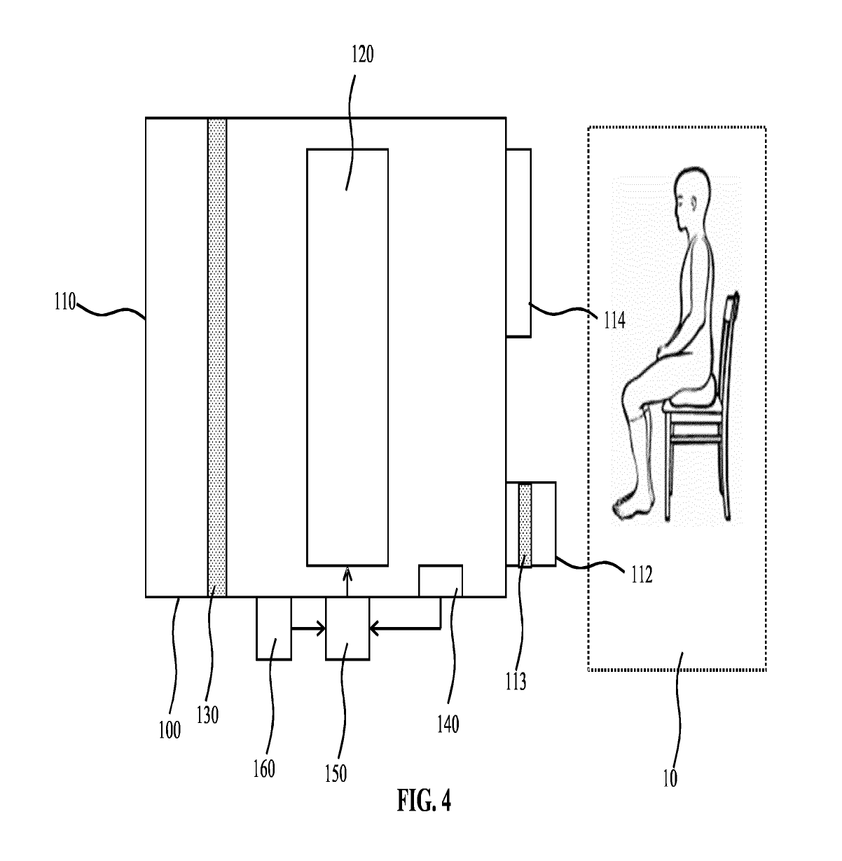

In a preferred embodiment, an example of which is schematically depicted in FIG. 4, the air purification apparatus 100 further comprises a proximity sensor 160 adapted to detect a presence in the region 10. Such proximity sensors are well-known per se, and may be implemented in any suitable manner, e.g. an infrared sensor, a radar device, an ultrasound sensor, a microphone, a camera or the like. In this embodiment, the controller 150 is further responsive to the proximity sensor 160 and may be adapted to switch the air purification apparatus 100, i.e. the air movement device 120, from a standby configuration to the first configuration upon the detection of a person entering the region 10 with the proximity sensor 160. The controller 150 may be further adapted to switch the air purification apparatus 100, i.e. the air movement device 120, from the first configuration to the standby configuration upon the detection of a person leaving the region 10 with the proximity sensor 160. This further improves the energy efficiency of the air purification apparatus 100, because the first configuration is only engaged when a person is present in the region 10.

In an embodiment, the air purification apparatus 100 may further comprise motion tracking sensor functionality, which may be implemented by the proximity sensor 160 or by a separate motion tracking sensor (not shown). Such motion tracking may be used to track the motion of a person across the target space in which the air purification apparatus 100 is positioned.

Such motion tracking for instance is advantageous in case the air purification apparatus 100 contains multiple directional vent arrangements each comprising a directional inlet 112 and a directional outlet 114, with each directional vent arrangement aimed at a different region of the target space, such that the controller 150 may switch to a first directional vent arrangement to a second directional vent arrangement upon receiving motion tracking information of the person moving from a region at which the first directional vent arrangement is aiming to a region at which the second directional vent arrangement is aiming. As will be readily understood by the skilled person, in such an embodiment each of the directional vent arrangements is fluidly coupled to the major vent 110 such that the air movement device 120 may move air between the directional air inlet 112 and the major vent 110 in the first configuration and between the major vent 110 and the directional air outlet 114 in the second configuration of each directional vent arrangement. This may be achieved in any suitable manner, for instance by including a valve arrangement such as valves in each directional inlet 112 and the directional outlet 114 under control of the controller 150, with the controller 150 adapted to open or shut the appropriate directional inlets 112 and directional outlets 114 to ensure that the appropriate directional vent arrangement is fluidly connected to the major vent 110 in the appropriate configuration, i.e. the first configuration or the second configuration.

Alternatively or additionally, the directional inlet 112 and the directional outlet 114 each may comprise an actuator responsive to the controller 150, which actuator is configured to adjust the respective aiming directions of the directional inlet 112 and the directional outlet 114, such that the controller 150 may adjust the aim of the directional inlet 112 and the directional outlet 114 in response to the received motion tracking information. By way of non-limiting example, each of the directional inlet 112 and the directional outlet 114 may comprise a curved tubular section having a slanted end surface, which curved tubular section may be rotated by the actuator to all the aim of the curved tubular section. Many other suitable configurations of such aim-adjustable directional inlets and directional outlets will be immediately apparent to the skilled person and may be equally contemplated for use in the air purification apparatus 100 according to embodiments of the present invention.

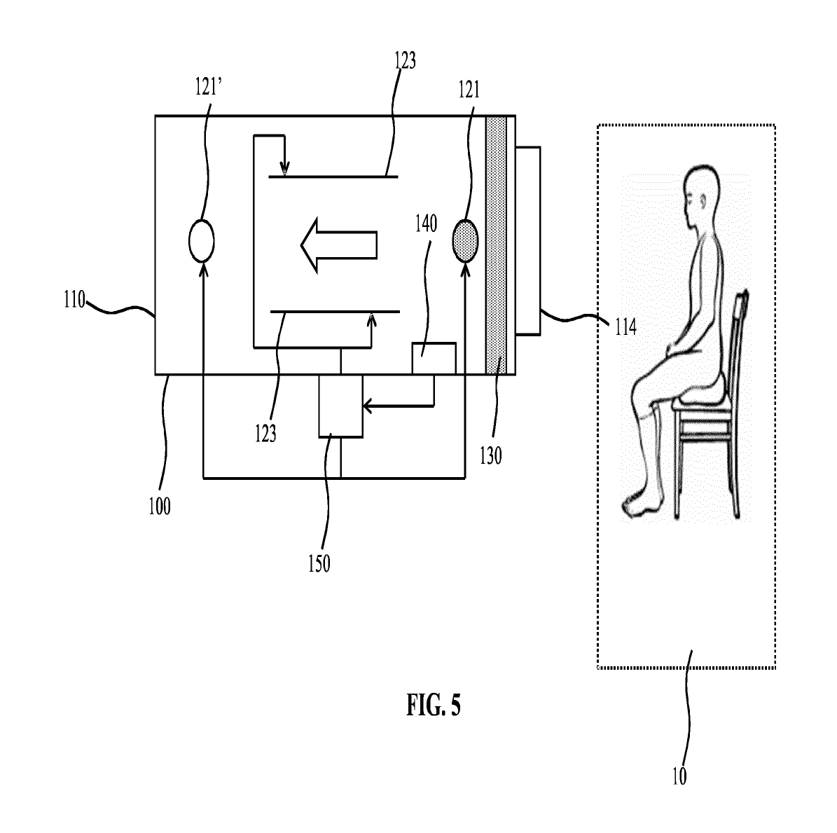

FIG. 5 schematically depicts a particularly advantageous embodiment of the air purification apparatus 100, in which the air movement apparatus 120 is implemented by an ionic wind generator. As is well-known per se, ionic wind generators are particularly energy-efficient devices for generating an air flow, as an air flow may be generated with less energy and less noise compared to e.g. fans or air pumps. The ionic wind generator comprises an electrode arrangement including a charging electrode 121 and a counter electrode 123 laterally displaced from the charging electrode 121. In order to be able to reverse the air flow direction of the air purification apparatus 100, the electrode arrangement may further comprise a further charging electrode 121′ such that the counter electrode 123 is arranged between the charging electrode 121 and the further charging electrode 121′. The counter electrode 123 typically is constructed in a way such as not to generate a corona discharge. This for example may be achieved by controlling the size and edge shape of the counter electrode 123, e.g. to ensure that the counter electrode 123 does not contain sharp edges and is large enough to avoid corona discharge effects around the counter electrode 123. The counter electrode 123 may have any suitable shape, e.g. may be arranged as one or more plate electrodes or as a tubular or other closed body electrode extending between the charging electrode 121 and the further charging electrode 121′. As will be readily understood by the skilled person, the desired air flow direction through the air purification apparatus 100 may be invoked by applying the appropriate high-voltage to one of the small-sized charging electrodes 121, 121′ in order to generate the corona discharge effect responsible for the generation of the ionic wind, preferably a positive voltage relative to the counter electrode 123, whilst passivating the other of the charging electrodes 121, 121′, e.g. by keeping the other charging electrode at a fixed potential such as ground. In this manner, an air flow is generated from the directional air inlet to the major vent 110 in the first configuration as indicated by the block arrow in FIG. 5. This for example may be achieved by grounding the charging electrode 121′ proximal to the major vent 110 and the provision of the high voltage to the charging electrode -121 proximal to the directional vent arrangement including the directional air inlet and the directional air outlet. In FIG. 5, the directional air inlet coincides with the directional air outlet, i.e. the directional vent arrangement comprises a single directional port 114.

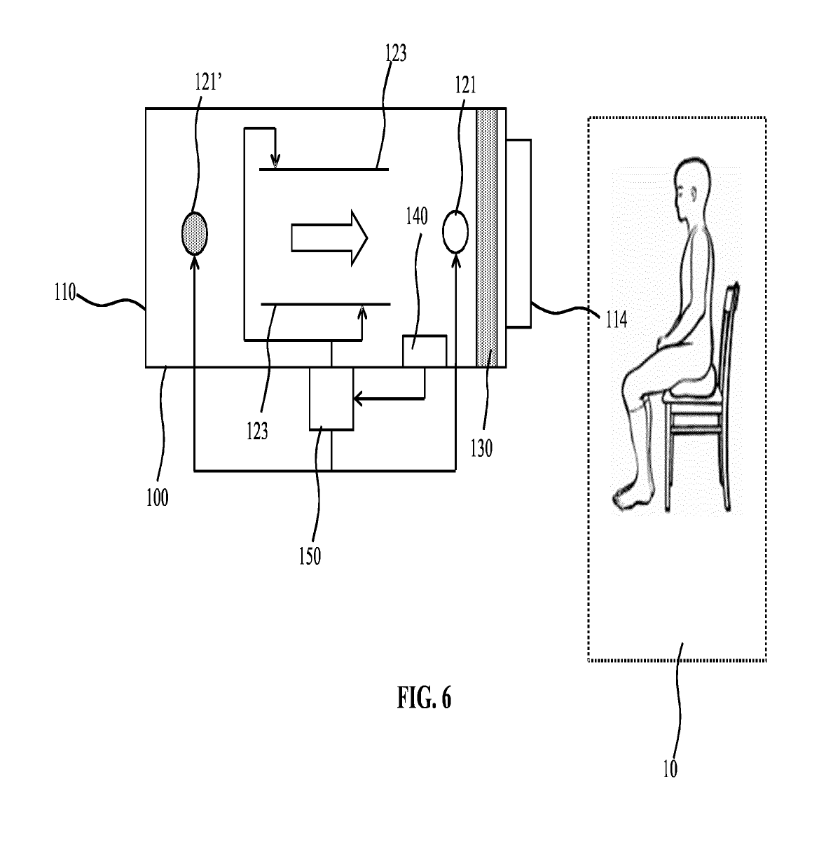

In order to switch the air movement direction generated with the ionic wind generator, the controller 150 may be adapted to reverse the polarity of the charging electrodes 121, 121′ as schematically depicted in FIG. 6 to generate the air movement from the major port 110 to the directional outlet (i.e. directional port 114) as indicated by the block arrow in FIG. 6. In the air purification apparatus 100 schematically depicted in FIGS. 5 and 6, one or more pollutant removal structures 120 as explained in more detail above may be placed in any suitable location in the flow path through the air purification apparatus 100. It should be understood that the pollutant removal structure 120 is located in between the charging electrodes 121, 121′ by way of non-limiting example only and that other locations, e.g. between the charging electrode 121′ and the major vent 110 or between the charging electrode −121 and the directional port 114 are equally feasible.

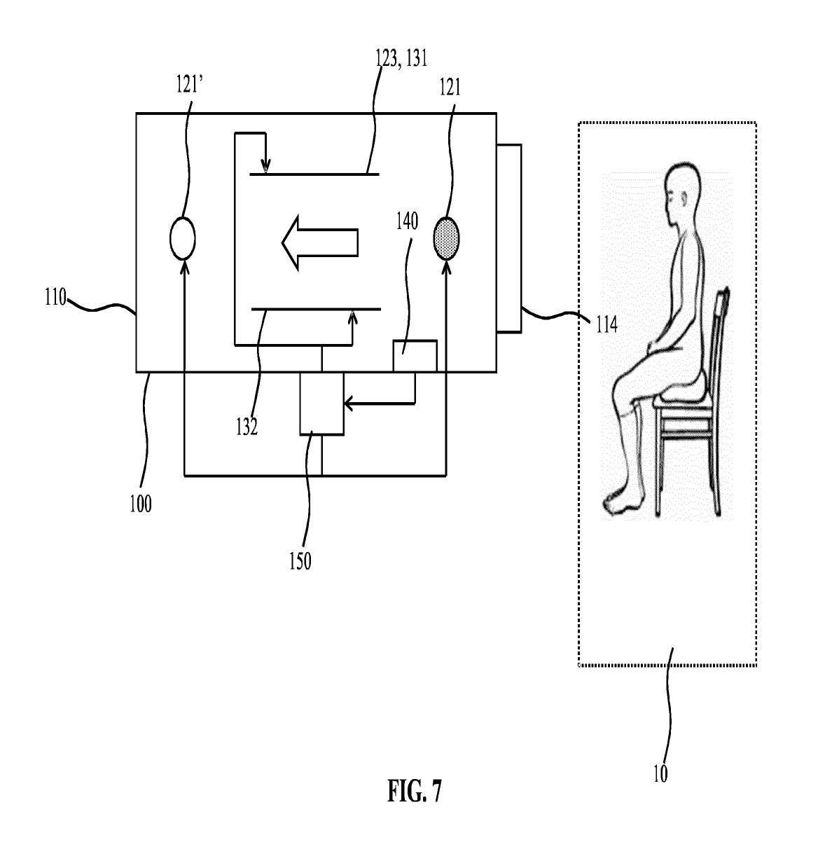

As is well-known per se, such an ionic wind device may alternatively be used for effective and energy efficient particle removal by combining it with a pollutant removal structure in the form of an electrostatic precipitation unit. FIG. 7 schematically depicts a particularly advantageous embodiment of the air purification apparatus 100, in which the air movement apparatus 120 is implemented by an ionic wind generator as described above with additional precipitation unit including opposing electrode plates 131 and 132 that electrostatically capture the pollutants charged by the charging electrode e.g. to capture charged particles removed from the region 10. This may be achieved by application of a potential difference between the respective plates 131, 132. One of the plates 131, 132 (here plate 131) may also act as the counter electrode 123 of the charging electrodes 121, 121′ or alternatively a separate counter electrode 123 (not shown) may be provided. The precipitation unit typically extends between the charging electrodes 121, 121′. Upon applying the appropriate high-voltage to the selected charging electrode, e.g. charging electrode 121 or further charging electrode 121′, in order to generate the corona discharge effect responsible for the generation of the ionic wind, which as previously mentioned preferably is a positive voltage relative to the counter electrode 123, e.g. to at least one of the plates 131, 132 of the precipitation unit acting as the counter electrode, an air flow is generated from the directional air inlet to the major vent 110 in the first configuration as indicated by the block arrow in FIG. 7. As explained above, the other charging electrode is redundant in this mode of operation and is consequently pacified, i.e. rendered inactive, e.g. by connecting it to a fixed potential, e.g. ground.

In order to switch the air movement direction generated with the ionic wind generator, the controller 150 may be adapted to reverse the polarity of the charging electrodes 121, 121′ as previously explained with the aid of FIG. 6.

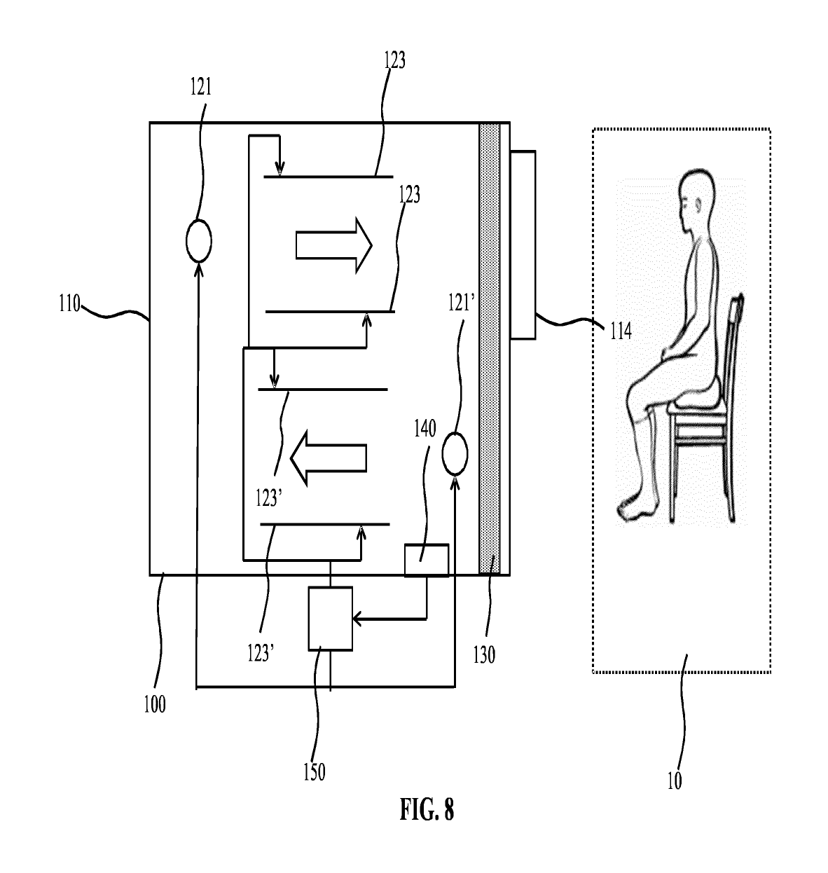

Alternatively, in embodiments of the air purification apparatus 100 in which it may not be possible to change the polarity of the charging electrodes 121, 121′, the air purification apparatus 100 may comprise two individually controllable sets of counter electrodes 123, 123′, with the counter electrode(s) 123 arranged to generate an air flow in cooperation with the individually controllable charging electrode 121 and the further counter electrode(s) 123′ arranged to generate an air flow in cooperation with the individually controllable further charging electrode 121′, as schematically depicted in FIG. 8, with the block arrows identifying the induced air flow directions. As before, the charging electrode 121 may be located proximal to the major vent 110 with its counter electrode(s) 123 laterally displaced towards the directional port 114 and the further charging electrode 121′ may be located proximal to the directional port 114 with its counter electrode(s) 123 laterally displaced towards the major vent 110. The respective counter electrode arrangements 123, 123′ may be located adjacent to each other although other suitable configurations, e.g. in which the counter electrode(s) 123 are laterally displaced to the further counter electrode(s) 123′ may also be contemplated. The embodiments of the air purification apparatus 100 schematically depicted in FIG. 8 may further comprise one or more pollutant removal structures 130 in any suitable location as previously explained in more detail with the aid of FIG. 5.

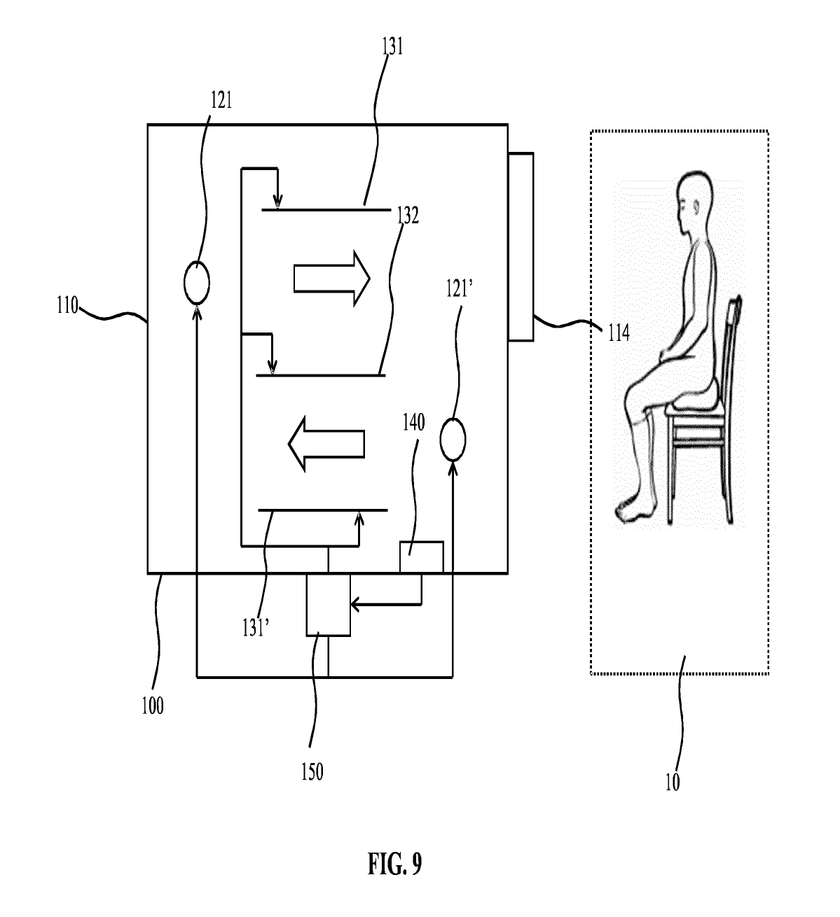

FIG. 9 schematically depicts another embodiment of the air purification apparatus 100. This embodiment is the same as the embodiment in FIG. 8 other than for the implementation of the one or more pollutant removal structures 130 as an electrostatic precipitation unit as previously explained in more detail with the aid of FIG. 7. In this embodiment, the electrostatic precipitation unit comprises the counter electrodes 131, 131′ as well as a common electrode 132 in between the counter electrodes 131, 131′. During operation, the common electrode 132 may be kept at a different potential to the counter electrodes 131 or the further counter electrode 131′, e.g. at the same potential as the active charging electrode, i.e. charging electrode 121 or further charging electrode 121′, to cause the electrostatic precipitation of the pollutants charged by the active charging electrode.

It is noted for the avoidance of doubt that such electrostatic precipitation units are well-known per se and that any suitable implementation of such well-known devices may be contemplated. For example, at least one of the electrodes 131, 132 of the electrostatic precipitation unit may carry a catalyst for catalytic conversion of a pollutant (e.g. a gas or a biohazard) into a harmless reaction product. A further benefit of such an electrostatic precipitation unit is that it may aid in disinfecting the air sucked into the air purification apparatus 100 from the region 10, as it is well-known per se that an electrostatic precipitation unit can be used to eliminate bacteria from air.

At this point, it is noted that the embodiment of the air purification apparatus 100 is by way of non-limiting example only, and that many modifications may be contemplated without departing from the teachings of the present invention. For example, in case a pollutant sensor 140 contains a charging electrode, e.g. in the case of some PM sensors, the pollutant sensor 140 and the electrostatic precipitation unit may share a charging electrode to reduce the cost of the air purification apparatus 100. It should be understood that the discussed designs of the ionic wind device or the designs of the ionic wind device with additional precipitation unit are merely exemplary, and that designs using more than 1 charging and/or grounding electrode on each side of the precipitation unit and/or multiple plate precipitation units in between the electrodes are equally feasible. Further straightforward design variations include the use of advanced geometries for the electrodes and the plates. As a further example, although a single directional port 114 is depicted, it should be understood that it is equally feasible that the directional vent arrangement comprises a separate directional inlet 112 and directional outlet 114 as shown in FIG. 1-4, in which one of the directional inlet 112 and directional outlet 114 may be fluidly connected to the major vent 110 through use of one or more valves, which may be controlled by the controller 150 or alternatively may be forced in an open or shut position depending on the direction of the air flow, e.g. a hinged flap covering the directional inlet 112 and facing the major vent 110 and a hinged flap on the directional outlet 114 and facing the region 10.

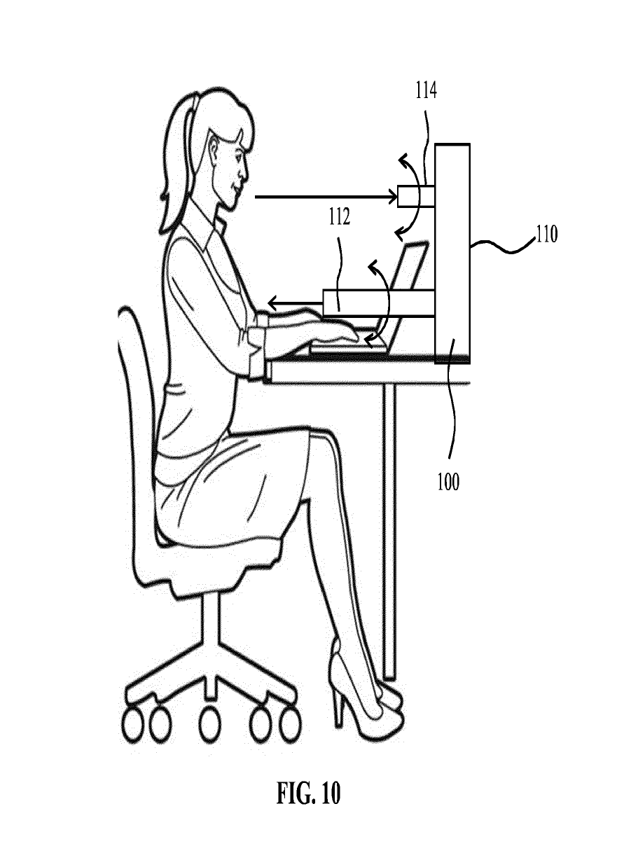

FIG. 10 schematically depicts an embodiment of air purification apparatus 100 in which the directional air inlet 112 and the directional air outlet 114 may be adjustably aimed as indicated by the curved arrows. In this embodiment, at least part of the air purification apparatus 100 may be mountable as a desktop device, for example to draw in air exhaled by a person sitting behind the desk through the directional air inlet 112 and expelling the air through the major vent 110 in the first configuration and to deliver purified air to that person that is drawn in through the major vent 110 and delivered through the directional air outlet 114 in the second configuration. As previously explained, the aim of the directional air inlet 112 and the directional air outlet 114 may be adjusted by the controller 150 in response to motion tracking (or positioning) information obtained with the proximity sensor 160 and/or a separate motion detector sensor. Alternatively, the aiming direction of the directional air inlet 112 and/or the directional air outlet 114 may be manually adjustable.

In an embodiment, the directional air inlet 112 may be aimed at a region several centimetres, e.g. 10 cm or more, below the nose of the person sitting behind the desk such as to suck in air that is exhaled by the person into that region when the person is breathing through his or her nose. In this manner, an air sample indicative of the exhaled air quality may be obtained through the directional air inlet 112. The directional air inlet 112 may be positioned such that the desktop surface acts as a guide for the air stream sucked into the directional air inlet 112. For example, the directional air inlet 112 may be shaped as an elongate conduit resting on or hovering just above the desktop surface. The directional air outlet 114 may be aimed at the face of the person sitting behind a desk such that the purified air delivered through the directional air outlet 114 in the second configuration of the air purification apparatus 100 may be directly inhaled by the person behind the desk. In this embodiment, it may be preferable that the outlet area of the directional air outlet 114 is relatively large to reduce the air flow speed through the directional air outlet 114 as previously explained in order to limit the discomfort experienced by the person sitting behind the desk. Furthermore, in this embodiment the pollutant sensor 140 advantageously may be a sensor adapted to detect malodour, e.g. a VOC sensor or the like, such that such malodours can be effectively removed before spreading to adjacent desk areas, thereby preventing embarrassment as previously explained.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to advantage.

1. An air purification apparatus for purifying air in a target space external to the apparatus, comprising:
at least one pollutant removal structure for removing a pollutant from the air in fluid connection with a major vent and a directional vent arrangement comprising:
a directional inlet opposite to the major vent for drawing air into the air purification apparatus from a region of the target space in an aiming direction of the directional inlet; and
a directional outlet opposite to the major vent for expelling air in a further aiming direction towards the region;
an air movement device configured to move air from the directional inlet to the major vent in a first configuration and to move air from the major vent to the directional outlet through the at least one pollutant removal structure in a second configuration, the air movement device being responsive to a controller;
a sensor arranged to determine a concentration of the pollutant in the air in said region when the air movement device is in the first orientation, wherein the controller is responsive to the sensor and is adapted to switch the air movement device from the first configuration to the second configuration upon the concentration of the pollutant exceeding a defined pollutant concentration threshold;
wherein:
the air movement device comprises an electrode arrangement for generating an ionic wind, the electrode arrangement including opposing charging electrodes and a counter electrode arrangement in between the opposing charging electrodes;
the controller is adapted to reverse the polarity of the opposing charging electrodes between the first configuration and the second configuration.

2. The air purification apparatus of claim 1, further comprising a proximity sensor for detecting a person in said region, the controller being further responsive to the proximity sensor.

3. The air purification apparatus of claim 2, wherein the controller is adapted to:
switch the air movement device from a standby configuration to the first configuration upon the detection of a person entering said region with the proximity sensor; and/or
switch the air movement device from the first configuration to the standby configuration upon the detection of a person leaving said region with the proximity sensor.

4. The air purification apparatus of claim 1, wherein at least one of the aiming direction and the further aiming direction is adjustable.

5. The air purification apparatus of claim 4, further comprising a motion detector, wherein the controller is adapted to adjust at least one of said aiming direction and said further aiming direction in response to the motion detector.

6. The air purification apparatus of claim 1, wherein the inlet area of the directional inlet is smaller than the outlet area of the directional outlet.

7. The air purification apparatus of claim 1, wherein the directional inlet and the directional outlet coincide.

8. The air purification apparatus of claim 1, wherein the air movement device is configured to move air from the directional inlet to the major vent through the at least one pollutant removal structure in the first configuration.

9. The air purification apparatus of claim 1, wherein the controller is adapted to periodically switch the air movement device from the second configuration to the first configuration to determine an actual concentration of the pollutant in the air in said region with the sensor.

10. The air purification apparatus of claim 1, wherein the apparatus comprises a plurality of said directional vent arrangements each aimed at a different region of the target space, each directional vent arrangement comprising a valve arrangement.

11. The air purification apparatus of claim 1, further comprising a further pollutant removal structure in the directional inlet.

12. The air purification apparatus of claim 1, wherein the counter electrode arrangement includes a first counter electrode arrangement adapted to cooperate with a first charging electrode of said opposing charging electrodes and a second counter electrode arrangement adapted to cooperate with a second charging electrode of said opposing charging electrodes, optionally wherein the opposing charging electrodes are longitudinally displaced relative to each other.

13. The air purification apparatus of claim 1, wherein the at least one pollutant removal structure comprises at least one electrostatic precipitation device.
